(19) United States
(12) Patent Application Publication
(10) Pub. No.: US 2004/0245065 A1
(43) Pub. Date: Dec. 9, 2004

(54) Centrifugal clutch

(76) Inventor: James A. Rice, Muskego, WI (US)

Correspondence Address: MICHAEL BEST & FRIEDRICH, LLP, 100 E WISCONSIN AVENUE, MILWAUKEE, WI, 53202, US

(21) Appl. No.: 10/457,141

(22) Filed: Jun. 9, 2003

(51) Int. Cl. F16D 43/18

(52) U.S. Cl. 192/105 BA

(57) ABSTRACT

A centrifugal clutch including a hub being rotatable about a central axis and at least two shoes supported by the hub for co-rotation with the hub. The shoes are configured for outward displacement relative to the central axis upon rotation of the hub to engage the clutch. The centrifugal clutch also includes at least one spring coupling the at least two shoes. The at least one spring is configured as a resilient clip having a shape defined by more than one radius and biasing the at least two shoes toward the central axis to disengage the clutch.

### FIELD OF THE INVENTION

This invention relates generally to power transmission devices, and more particularly to centrifugal clutches.

### BACKGROUND OF THE INVENTION

Many different designs and configurations of centrifugal clutches are available for use in power transmission applications. Generally, a centrifugal clutch includes a hub rotated by a driving member and weights resiliently coupled to the hub for co-rotation with the hub. The hub and weights are usually positioned within a drum, which is rotatable relative to the hub, and is often coupled to an output shaft transferring the torque of the driving member. Sufficient rotation of the hub results in the weights being “thrown out,” or moved outward from the hub's center of rotation as a result of centrifugal force. Typically, the weights frictionally engage the drum after being “thrown out,” thus causing the drum to co-rotate with the hub allowing a transfer of torque between the hub and drum.

### SUMMARY OF THE INVENTION

The present invention provides a centrifugal clutch including a hub being rotatable about a central axis, at least two shoes supported by the hub for co-rotation with the hub, and at least one spring coupling the at least two shoes. The spring is configured as a resilient clip and biases the shoes toward the central axis upon rotation of the hub.

The present invention also provides a centrifugal clutch including a hub being rotatable about a central axis, the hub including at least one shoulder formed thereon, at least two shoes supported by the shoulder for co-rotation with the hub, and at least one spring coupling the shoes. The at least spring is configured as a resilient clip and biases the shoes toward the central axis upon rotation of the hub.

### BRIEF DESCRIPTION OF THE DRAWINGS

In the drawings, wherein like reference numerals indicate like parts:

FIG. 1 is an exploded perspective view of a centrifugal clutch embodying the present invention;

FIG. 2 is an assembled perspective view of the clutch of FIG. 1; and

FIG. 3 is an exploded perspective view of a powered device using the clutch of FIG. 1.

Before any features of the invention are explained in detail, it is to be understood that the invention is not limited in its application to the details of construction and the arrangements of components set forth in the following description or illustrated in the drawings. The invention is capable of other constructions and of being practiced or of being carried out in various ways. Also, it is to be understood that the phraseology and terminology used herein is for the purpose of description and should not be regarded as limited.

### DETAILED DESCRIPTION

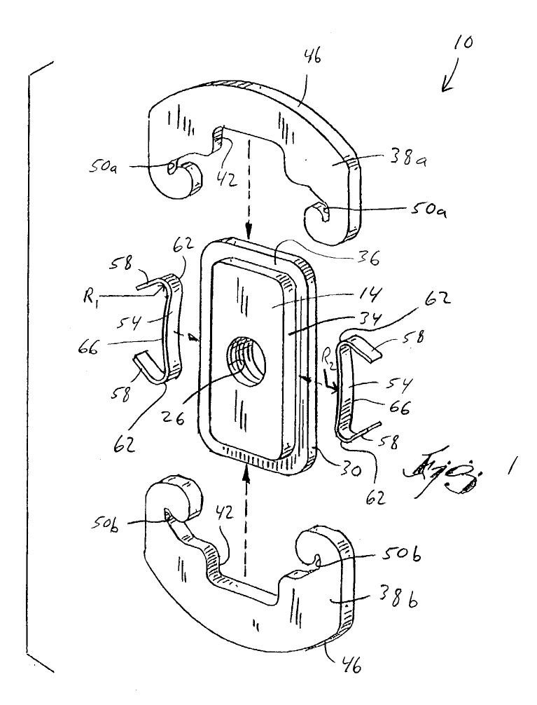

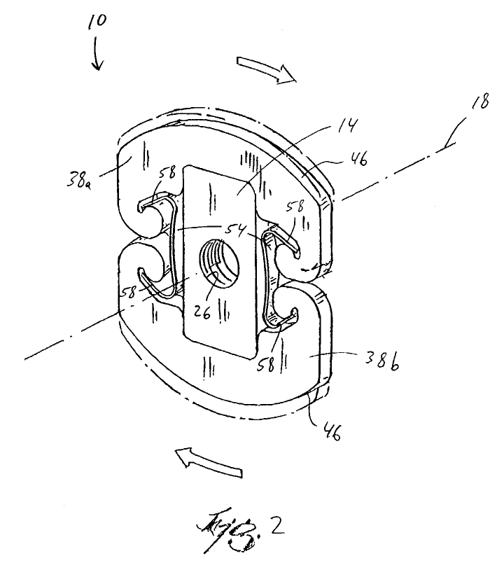

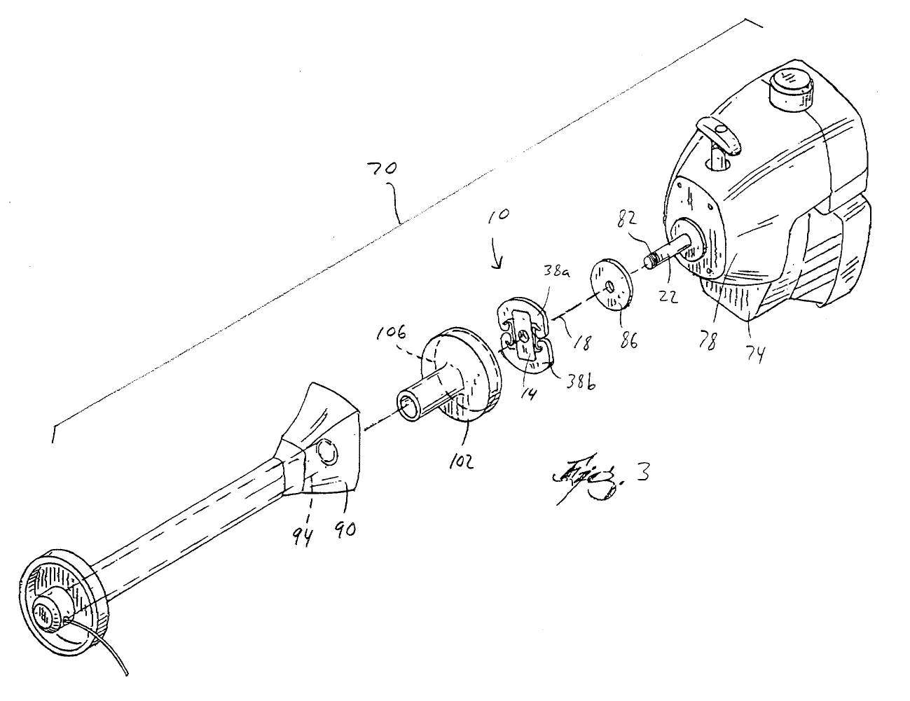

With reference to FIG. 1, a centrifugal clutch 10 is shown exploded into its individual components. The centrifugal clutch 10 includes a hub 14 having a central axis 18 (see FIG. 2) passing therethrough. The hub 14 is rotatable about the central axis 18 by a driving member 22 (see FIG. 3), such as a driveshaft or crankshaft of an engine. A threaded aperture 26 coaxial with the central axis 18 is formed through the hub 14, allowing a threaded coupling with the driving member 22. However, in other constructions of the hub (not shown), the hub 14 may utilize any of a number of mechanical couplings to couple to the driving member 22. Such couplings include, but are not limited to, splined couplings, shaft & keyway couplings, D-shaped couplings, pinned couplings, friction or interference fits, snap-fits, welds, and so forth.

The hub 14 is configured in a generally rectangular shape, and includes at least one shoulder 30 therearound defining a driving surface 34 and a retaining surface 36: Opposing weights, or shoes 38a, 38b, are slidably supported by the shoulder 30. The shoes 38a, 38b abut the retaining surface 36 such that the shoes 38a, 38b are axially supported in at least one direction along the central axis 18. In other constructions of the clutch (not shown), the hub may be configured with two opposing shoulders, with each shoulder defining a respective retaining surface such that the shoes 38a, 38b are axially supported between the opposing retaining surfaces in both directions along the central axis 18.

Each shoe 38a, 38b includes a recess 42 formed therein that is sized to snugly engage the driving surface 34 of the hub 14. Each shoe 38a, 38b also includes an outer frictional surface 46 defined by a particular radius coinciding with the central axis 18. Further, shoe 38a includes opposite ends having notches 50a formed therein with rounded or curved ends. Similarly, shoe 38b includes opposite ends having notches 50b formed therein with rounded or curved ends.

Upon assembling the shoes 38a, 38b with the hub 14, resilient spring clips 54 couple together the opposing shoes 38a, 38b. The spring clips 54 inwardly bias the shoes 38a, 38b toward the central axis 18 and maintain the shoes 38a, 38b engaging the hub 14. The spring clips 54 include opposite end portions, or fingers 58, which engage the notches 50a, 50b of the opposing shoes 38a, 38b. The fingers 58 fit loosely within the notches 50a, 50b to allow movement of the fingers 58 within the notches 50a, 50b. This allows the spring clips 54 to assume a flexed shape upon outward movement of the shoes 38a, 38b relative to the central axis 18. Also, the notches 50a, 50b allow the spring clips 54 to flex without binding or being undesirably constrained. The spring clips 54 and shoes 38a, 38b are configured such that the fingers 58 of the spring clips 54 face outwardly from the central axis 18. However, the spring clips 54 and notches 50a, 50b may be configured such that the fingers 58 of the spring clips 54 face inwardly toward the central axis 18.

Curved portions 62 couple the fingers 58 and middle portions 66 of the spring clips 54, and are defined by a particular radius “R₁.” Also, the middle portions 66 define a larger radius than the curved portions 62, the middle portions 66 being designated by a particular radius “R₂.” The curved portions 62 and middle portions 66 are formed with the multiple radii R₁ and R₂ to more evenly distribute the stress in the spring clips 54 while they flex under load. Generally, the operational life of the clutch 10, which is most often determined by the life of the spring clips 54, is enhanced by providing the spring clips 54 with multiple radii R₁ and R₂. For the applications of the clutch 10 discussed herein, the relatively small size of the spring clips 54 (compared to a larger clutch capable of transferring greater amounts of torque) makes them especially vulnerable to over-stressing and fatigue. The radii R₁ and R₂ formed in the spring clips 54 more evenly distribute stress in the spring clips 54 to help prevent over-stressing and fatigue failure of the spring clips 54.

Radius R₁ of the curved portions 62 is sized between about 0.020 inches 0.051 centimeters) and about 0.125 inches 0.318 centimeters). However, the radius R₁ may be scaled appropriately depending on the size of the clutch 10, and the desired operating life of the clutch 10. Likewise, radius R₂ of the middle portions 66 is sized between about 0.5 inches 1.27 centimeters) and about 1.25 inches (3.18 centimeters), and may be scaled appropriately depending on the size of the clutch 10, and the desired operating life of the clutch 10.

With reference to FIG. 2, the clutch 10 is shown in a “disengaged” configuration, in which the shoes 38a, 38b are fully inwardly retracted relative to the hub 14, and an “engaged” configuration (shown in phantom lines), in which the shoes 38a, 38b are outwardly displaced relative to the hub 14, both configurations being described in more detail below. The clutch 10 automatically adjusts between the disengaged and engaged configurations upon rotating the hub 14 about the central axis 18. As the hub 14 reaches sufficient rotational speed about the central axis 18, centrifugal forces acting on the shoes 38a, 38b overcome the biasing force exerted by the spring clips 54, resulting in the outward displacement of the shoes 38a, 38b relative to the central axis 18. Generally, as the rotational speed of the hub 14 increases, the amount of outward displacement of the shoes 38a, 38b also increases.

With reference to FIG. 3, the clutch 10 is shown being employed with a powered device 70. The powered device 70 may be in the form of a string trimmer, blower, or vacuum, for example, among other types of powered devices 70. The device 70 includes a power source 74 housed within a first housing portion 78. The power source 74 may include a conventional gas-operated, ½-horsepower two-stroke engine. However, the power source 74 may also include any of a number engines, including a propane-operated engine, a natural gas-powered engine, a four-stroke engine, and so forth. Further, the power source 74 may include an electric motor, an air-operated motor, a hydraulic motor, and so forth. The power source 74 is operable to provide torque to the driving member 22. The driving member 22 includes threads 82 allowing for a threaded coupling between the driving member 22 and the hub 14. More specifically, the driving member 22 threadably engages the threaded aperture 26 of the hub 14 upon assembly. A washer 86 may be inserted between a shoulder (not shown) formed in the driving member 22 and the clutch 10. As previously stated, other mechanical couplings joining the driving member 22 and hub 14 may include splined couplings, keyed couplings, D-shaped couplings, pinned couplings, friction or interference fits, snap-fits, welds, and so forth.

The powered device 70 may also include a second housing portion 90 supporting a driven member 94, such as an output shaft or intermediate shaft. The second housing portion 90 is coupled to the first housing portion 78 using conventional fasteners (not shown), such that the driving member 22 and driven member 94 are coaxially aligned. A drum 102 is coupled to the end of the driven member 94 facing the driving member 94. The drum 102 includes a recessed portion 106 defining an inner frictional surface (not shown). The recessed portion 106 of the drum 102 is sized to receive the clutch 10 therein, such that in the disengaged position, a radial clearance exists between the outer frictional surfaces 46 of the shoes 38a, 38b and the inner frictional surface of the drum 102. The drum 102 and driven member 94 may be threadably coupled like the driving member 22 and hub 14, however, the drum 102 and driven member 94 may also be coupled via a splined coupling, a keyed coupling, a D-shaped coupling, a pinned coupling, a friction or interference fit, a snap-fit, by welds, and so forth.

The drum 102 is maintained in a position housing the clutch 10 by coupling the first and second housing portions 78, 90. As previously stated, the clutch 10 automatically adjusts between the disengaged and engaged configurations upon rotating the hub 14 about the central axis 18. Upon sufficient rotation of the hub 14 about the central axis 18, centrifugal forces acting on the shoes 38a, 38b overcome the biasing force exerted by the spring clips 54, resulting in the outward displacement of the shoes 38a, 38b relative to the central axis 18. Generally, as the rotational speed of the hub 14 increases, the amount of outward displacement of the shoes 38a, 38b also increases. After the shoes 38a, 38b outwardly displace enough, the outer frictional surfaces 46 of the shoes 38a, 38b begin to frictionally engage the inner frictional surface of the drum 102 (i.e., the clutch 10 moving toward its engaged configuration). After initial engagement of the outer frictional surfaces 46 of the shoes 38a, 38b and the inner frictional surface of the drum 102, increased rotation of the hub 14 provides a progressive increase in frictional engagement of the frictional surfaces 46 of the shoes 38a, 38b and drum 102. As a result, progressive amounts of torque are transmittable from the clutch 10 to the drum 102, and subsequently to the driven member 94. Likewise, as the rotational speed of the clutch 10 is decreased (from a speed wherein the clutch 10 is in its engaged configuration), the centrifugal forces acting on the shoes 38a, 38b decrease, allowing the biasing forces of the spring clips 54 to inwardly displace the shoes 38a, 38b toward the clutch's disengaged configuration.

The clutch 10 may be configured to engage the drum 102 at any of a number of rotational speeds of the driven member 22. The thickness of the spring clips 54, more specifically, may be varied to affect the spring rate of the spring clips 54. In the exemplary construction, the thickness of the spring clips 54 may be between about 0.010 inches 0.025 centimeters) and about 0.060 inches 0.152 centimeters). As a result of varying the thickness of the spring clips 54, the biasing forces provided by the spring clips 54 to inwardly bias the shoes 38a, 38b will also be varied. Generally, thicker spring clips 54 have higher spring rates, thus providing an increased biasing force to the shoes 38a, 38b as compared to thinner spring clips 54 having lower spring rates. As a result, a clutch 10 including thicker spring clips 54 will engage the drum 102 at a higher rotational speed, as compared to a clutch 10 including thinner spring clips 54. For example, the clutch 10 may be configured with spring clips 54 which allow the clutch 10 to engage the drum 102 between about 4000 and 4500-RPM. However, the spring clips 54 may be varied accordingly to either increase or decrease the rotational speed at which the clutch 10 engages the drum 102.

The hub 14 is made from metal and manufactured using a powdered-metal molding process. However, the hub 14 may also be manufactured by machining billet material, die casting, and so forth. The shoes 38a, 38b are configured to be substantially identical in shape, size, and weight. As such, the shoes 38a, 38b may be manufactured using the same process. The shoes 38a, 38b are also made from metal and manufactured using a powdered-metal molding process, however they may also be manufactured using the other processes mentioned above. The hub 14 and shoes 38a, 38b may be made from any of a number of different metals, including steel, aluminum, and other various metal alloys. Secondary heat treatment in the form of hardening or tempering may also be performed on the hub and shoes 38a, 38b. The spring clips 54 are also made from metal and manufactured using a stamping process. The spring clips 54 may be stamped from annealed spring steel, and may be further subjected to a hardening process to affect the spring rates of the individual spring clips 54. However, the spring clips 54 may also be made from stainless steel or a variety of other metal alloys.

The configuration of the spring clips 54 and shoes 38a, 38b allow for a simplified automated assembly of the clutch 10, compared to a conventional centrifugal clutch. A conventional centrifugal clutch (not shown), for example, utilizes coil springs in tension to provide the biasing forces against outward displacement of the shoes. To assemble such a clutch, the springs are typically assembled onto the clutch by a manual process (e.g., by assembly line workers). A manual process is typically used because the orientation of the coil springs relative to the holes through which they must be placed requires dexterity which is not easily automated and would be complicated and expensive to achieve. However, the spring clips 54 are configured to be substantially identical to one another. As such, an automated process to assemble the spring clips 54 with the shoes 38a, 38b may be simplified, leading to a less complicated and less expensive clutch 10 as compared to a conventional clutch.

In an exemplary mass-production assembly process (not shown), bulk quantities of the shoes 38a, 38b and the hubs 14 may be placed in large, separate hoppers for handling bulk materials. The hoppers are equipped with vibratory feeding mechanisms to both feed and orient the shoes 38a, 38b and hubs 14 sequentially into a desired spatial position.

The spring clips 54 may be positioned into a feed mechanism which resembles a stapler. The feed mechanism may be used to orient the springs relative to the shoes 38a, 38b and the hubs 14.

A rotary table including multiple stations for executing serial assembly tasks may also be used in the assembly process. The vibratory feeders position the shoes 38a, 38b and hubs 14 onto various stations of the rotary table. More particularly, each station of the rotary table receives one hub 14 and two shoes 38a, 38b. The shoes 38a, 38b are already engaged with the hub 14 at a desired spatial position determined by the vibratory feeding mechanisms. As the table indexes, the spring clips 54 may be inserted into the notches 50a, 50b of the shoes 38a, 38b by the feed mechanism at a predetermined position and orientation relative to the hub 14 and shoes 38a, 38b. The final station of the rotary table ejects a completed clutch 10 which may be placed directly into a package for shipping.

I claim:

1. A centrifugal clutch comprising:
a hub being rotatable about a central axis;
at least two shoes supported by the hub for co-rotation with the hub and configured for outward displacement relative to the central axis upon rotation of the hub to engage the clutch; and
at least one spring coupling the at least two shoes, the at least one spring being configured as a resilient clip having a shape defined by more than one radius, the at least one spring biasing the at least two shoes toward the central axis to disengage the clutch.

2. The centrifugal clutch of claim 1, wherein the hub defines a generally rectangular shape.

3. The centrifugal clutch of claim 2, wherein a first shoe is supported at one end of the hub, and a second shoe is supported at an opposite end of the hub.

4. The centrifugal clutch of claim 1, wherein the hub includes at least one shoulder supporting the at least two shoes, the shoulder defining at least one driving surface substantially parallel with the central axis, the at least one driving surface allowing movement there along of the at least two shoes relative to the central axis.

5. The centrifugal clutch of claim 4, wherein the shoulder defines at least one retaining surface substantially transverse to the central axis, the at least one retaining surface preventing movement of the at least two shoes in at least one direction along the central axis.

6. The centrifugal clutch of claim 1, further comprising a threaded aperture defining the central axis, wherein the threaded aperture is engageable by a drive member to rotate the hub about the central axis.

7. The centrifugal clutch of claim 1, wherein the at least two shoes includes a first shoe and a second shoe positioned opposite the first shoe.

8. The centrifugal clutch of claim 7, wherein the at least one spring couples an end of the first shoe to an adjacent end of the second shoe.

9. The centrifugal clutch of claim 8, further comprising a second spring coupling an opposite end of the first shoe to an adjacent end of the second shoe.

10. The centrifugal clutch of claim 1, wherein the at least one spring includes a thickness between about 0.010 inches (0.025 centimeters) and about 0.060 inches (0.152 centimeters).

11. The centrifugal clutch of claim 1, wherein the resilient clip includes a middle portion and opposite end portions, and wherein the resilient clip includes respective curved portions coupling the respective end portions and the middle portion.

12. The centrifugal clutch of claim 11, wherein the curved portions define a radius between about 0.020 inches (0.051 centimeters) and about 0.125 inches (0.318 centimeters).

13. The centrifugal clutch of claim 11, wherein the middle portion defines a radius between about 0.5 inches (1.27 centimeters) and about 1.25 inches (3.18 centimeters).

14. The centrifugal clutch of claim 1, wherein the at least two shoes each include a substantially singular thickness.

15. A centrifugal clutch comprising:
a hub being rotatable about a central axis, the hub including at least one shoulder formed thereon;
at least two shoes supported by the shoulder for co-rotation with the hub and configured for outward displacement relative to the central axis upon rotation of the hub to engage the clutch; and
at least one spring coupling the at least two shoes, the at least one spring being configured as a resilient clip, the spring biasing the shoes toward the central axis to disengage the clutch.

16. The centrifugal clutch of claim 15, wherein the hub defines a generally rectangular shape.

17. The centrifugal clutch of claim 15, wherein a first shoe is supported at one end of the shoulder, and a second shoe is supported at an opposite end of the shoulder.

18. The centrifugal clutch of claim 17, wherein the spring couples an end of the first shoe to an adjacent end of the second shoe.

19. The centrifugal clutch of claim 18, further comprising a second spring coupling an opposite end of the first shoe to an adjacent end of the second shoe.

20. The centrifugal clutch of claim 15, further comprising a threaded aperture defining the central axis, wherein the threaded aperture is engageable by a drive member to rotate the hub about the central axis.

21. The centrifugal clutch of claim 15, wherein the at least one spring includes a thickness between about 0.010 inches 0.025 centimeters) and about 0.060 inches 0.152 centimeters).

22. The centrifugal clutch of claim 15, wherein the resilient clip includes a middle portion and opposite end portions, and wherein the resilient clip includes respective curved portions coupling the respective end portions and the middle portion.

23. The centrifugal clutch of claim 22, wherein the curved portions define a radius between about 0.020 inches 0.051 centimeters) and about 0.125 inches 0.318 centimeters).

24. The centrifugal clutch of claim 22, wherein the middle portion defines a radius between about 0.5 inches 1.27 centimeters) and about 1.25 inches (3.18 centimeters).

25. The centrifugal clutch of claim 15, wherein the first and second shoes each include a substantially singular thickness.

26. The centrifugal clutch of claim 15, wherein the shoulder defines at least one driving surface substantially parallel with the central axis, the at least one driving surface allowing movement there along of the at least two shoes relative to the central axis.

27. The centrifugal clutch of claim 15, wherein the shoulder defines at least one retaining surface substantially transverse to the central axis, the at least one retaining surface preventing movement of the at least two shoes in at least one direction along the central axis.

28. A method of assembling a centrifugal clutch comprising the steps of:
providing a hub for rotation about a central axis;
positioning at least two shoes to be supported by the hub for co-rotation with the hub and configured for outward displacement relative to the central axis upon rotation of the hub to disengage the clutch; and;
positioning at least one spring for coupling the at least two shoes, the at least one spring being configured as a resilient clip having a shape defined by more than one radius, the at least one spring biasing the at least two shoes toward the central axis to disengage the clutch.
